(19) United States
(12) Patent Application Publication
(10) Pub. No.: US 2024/0370308 A1
(43) Pub. Date: Nov. 7, 2024

(54) CPU RESOURCE CONTROL METHOD AND APPARATUS, AND COMPUTER-READABLE STORAGE MEDIUM

(71) Applicant: Black Sesame Technologies Co., Ltd., Wuhan (CN)

(72) Inventor: Wenhao He, Chengdu (CN)

(73) Assignee: Black Sesame Technologies Co., Ltd., Wuhan (CN)

(21) Appl. No.: 18/651,316

(22) Filed: Apr. 30, 2024

(30) Foreign Application Priority Data
May 5, 2023 (CN) 202310524165.8

(51) Int. Cl. G06F 9/50

(52) U.S. Cl. CPC G06F 9/5077; G06F 9/5038

(57) ABSTRACT

A CPU resource control method and apparatus, and a computer-readable storage medium are provided. The method includes: detecting CPU resources occupied by a plurality of processes in a virtual machine; taking a process among the plurality of processes that occupies the CPU resources over a preset threshold as a target process required to adjust a CPU to be used, and calculating, according to the number of times the target process has been adjusted, the number of CPUs to be used by the target process, as the number of times the target process has been adjusted increases, the number of CPUs to be used by the target process decreases until it reaches 1; no longer detecting the target process when the number of CPUs to be used by the target process is 1; and selecting at least one CPU from the plurality of CPUs for use by the target process.

### RELATED APPLICATION

This application claims the benefit under 35 U.S.C. § 119 (a) of the filing date of Chinese Patent Application No. 202310524165.8, filed in the Chinese Patent Office on May 5, 2023. The disclosure of the foregoing application is herein incorporated by reference in its entirety.

### TECHNICAL FIELD

The present disclosure relates to the field of computer technologies, and in particular, to a CPU resource control method and apparatus, and a computer-readable storage medium.

### BACKGROUND

In a symmetric multi processing (SMP) system, in order to effectively utilize computility of each CPU, an operating system may automatically perform CPU load balancing. This operation may cause process migration, such as migration of a process from a CPU A to a CPU B. This migration operation is implemented at a low level by a hardware mechanism called an inter processor interrupt (IPI).

As shown in FIG. 1, when the operating system is running in a virtual machine, the IPI originally implemented by the hardware mechanism may be implemented by a Hypervisor (a virtual machine monitor) in a specific manner below. A virtual inter processor interrupt (vIPI) sent by vCPU1 (a virtual CPU) in the virtual machine to vCPU2 may fall into the Hypervisor before being received by vCPU2. The hypervisor performs a series of combined software and hardware operations, and then the vIPI returns from the Hypervisor to the virtual machine to be received by vCPU2. From the perspective of the operating system in the virtual machine, the operating system cannot perceive the operation from falling into the monitor to returning to the virtual machine, and only observes that vIPI processing is more time-consuming than that on a physical CPU. From the perspective of the system as a whole, the entire vIPI operation from falling into the monitor to returning to the virtual machine performed by the Hypervisor introduces additional CPU overhead because an operation path is longer than that in an original direct hardware operation. The overhead occupies CPU resources of processes and is therefore a waste of CPU resources.

Furthermore, taking a Hypervisor of secure embedded L4 microkernel (sEL4, a type of virtual machine monitor) as an example, processing time of a single vIPI by some Hypervisors may be affected by a total number of vIPIs in the entire system, because all vIPIs in the entire system may be placed in a global queue and the hypervisor may traverse this global queue and perform corresponding operations sequentially on each vIPI. Therefore, if the virtual machine issues more vIPIs, the Hypervisor is required to process a longer global vIPI queue, and the overhead of processing a single vIPI may waste more CPU resources.

In order to reduce the waste of CPU resources, in related technologies currently, there is a technology for virtual machine vCPU load balancing in virtualization scenarios. However, an existing automatic CPU load balancing technology is incapable of identifying the increased CPU consumption due to the Hypervisor processing vIPIs, and only performs balancing based on a queue length of each CPU process. When there are more processes, a large number of processes are generated and migrated between CPUs, resulting in a large number of vIPIs. The generation of these vIPIs is originally intended to balance CPU computility resources, but results in a waste of a large amount of computility.

### SUMMARY

In order to overcome the above defects, the present disclosure is proposed to provide a CPU resource control method and apparatus, and a computer-readable storage medium that can reduce unnecessary vIPI and reduce a waste of CPU resources in virtualization application scenarios.

In a first aspect, the present disclosure provides a CPU resource control method, including: detecting CPU resources occupied by a plurality of processes in a virtual machine, wherein the virtual machine has a plurality of virtual CPUs; taking a process among the plurality of processes that occupies the CPU resources over a preset threshold as a target process required to adjust a CPU to be used, and calculating, according to the number of times the target process has been adjusted, the number of CPUs to be used by the target process, wherein as the number of times the target process has been adjusted increases, the number of CPUs to be used by the target process decreases until it reaches 1; no longer detecting the target process when the number of CPUs to be used by the target process is 1; and selecting, according to the number of CPUs to be used by the target process, CPU resources occupied by the target process, and remaining resources of the plurality of CPUs, at least one CPU from the plurality of CPUs for use by the target process.

Preferably, according to the CPU resource control method, prior to the step of taking the process among the plurality of processes that occupies the CPU resources over the preset threshold as the target process required to adjust the CPU to be used, the method further includes: setting a corresponding threshold for each of the plurality of processes.

Preferably, according to the CPU resource control method, the step of setting the corresponding threshold for each of the plurality of processes includes: setting the corresponding threshold for each process according to a degree of dependence of a task executed by the virtual machine on each process.

Preferably, according to the CPU resource control method, the step of setting the corresponding threshold for each of the plurality of processes includes: setting the corresponding threshold for each process according to a degree of impact of each process on stability of a running system of the virtual machine.

Preferably, according to the CPU resource control method, the method further includes: performing detection again after a preset time period when it is not detected that there is a process among the plurality of processes that occupies the CPU resources over the preset threshold.

Preferably, according to the CPU resource control method, the step of calculating, according to the number of times the target process has been adjusted, the number of CPUs to be used by the target process includes: when the total number of the plurality of CPUs is n and the number of times the target process has been adjusted is m, setting M=m+1 and the number of CPUs to be used by the target process to n/2^{M}.

Preferably, according to the CPU resource control method, the step of detecting CPU resources occupied by the plurality of processes in the virtual machine includes: querying, according to a preset configuration file recording the plurality of processes, the plurality of processes from the virtual machine and performing detection; and the step of no longer detecting the target process when the number of CPUs to be used by the target process is 1 includes: deleting the target process from the configuration file.

Preferably, according to the CPU resource control method, the step of selecting at least one CPU from the plurality of CPUs for use by the target process further includes: selecting the at least one CPU from the plurality of CPUs in ascending order of resource usage of the plurality of CPUs.

In a second aspect, the present disclosure provides a CPU resource control apparatus, including: a CPU resource detection module configured to detect CPU resources occupied by a plurality of processes in a virtual machine, wherein the virtual machine has a plurality of virtual CPUs; a CPU number calculation module configured to take a process among the plurality of processes that occupies the CPU resources over a preset threshold as a target process required to adjust a CPU to be used, and calculate, according to the number of times the target process has been adjusted, the number of CPUs to be used by the target process, wherein as the number of times the target process has been adjusted increases, the number of CPUs to be used by the target process decreases until it reaches 1; a detection control module configured to no longer detect the target process when the number of CPUs to be used by the target process is 1; and a CPU selection module configured to select, according to the number of CPUs to be used by the target process, CPU resources occupied by the target process, and remaining resources of the plurality of CPUs, at least one CPU from the plurality of CPUs for use by the target process.

In a third aspect, the present disclosure provides a computer-readable storage medium, storing a plurality of program codes, wherein the program codes are adapted to be loaded and run by a processor to perform the CPU resource control method.

The above one or more technical solutions in the present disclosure have at least one or more of the following beneficial effects.

The technical solution in the present disclosure, in which a process in the virtual machine whose occupation of CPU resources reaches a threshold is taken as a target process and a virtual CPU to be used is adjusted to achieve CPU load balancing, is different from the existing technical solution in that, as the number of times of load balancing increases, the number of CPUs configured for the target process gradually decreases, thereby reducing the number of vIPIs generated by migration of the target process between virtual CPUs, that is, reducing a waste of CPU resources in the virtual machine, until the number of virtual CPUs allocated to the target process is 1, and in this case, the number of virtual CPUs cannot be further reduced for the target process, that is, the waste of CPU resources in the virtual machine is minimized. Therefore, there is no need to detect the target process.

### BRIEF DESCRIPTION OF THE DRAWINGS

The content disclosed in the present disclosure will become more understandable with reference to the accompanying drawings. Those skilled in the art can easily understand that these accompanying drawings are for illustrative purposes only and are not intended to limit the protection scope of the present disclosure. In the drawings,

FIG. 1 is a diagram of a principle of CPU load balancing in the existing technical solution;

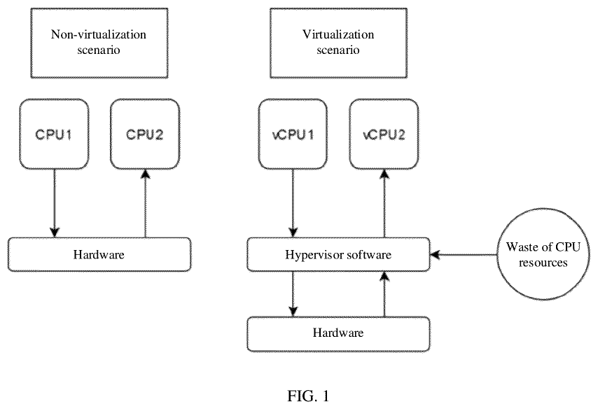

FIG. 2 is a flowchart of a CPU resource control method according to an embodiment of the present disclosure;

FIG. 3 is a flowchart of a CPU resource control method according to an embodiment of the present disclosure;

FIG. 4 is a flowchart of a principle of a CPU resource control method according to an embodiment of the present disclosure;

FIG. 5 is a flowchart of a principle of a CPU resource control method according to an embodiment of the present disclosure;

FIG. 6 is a block diagram of a CPU resource control apparatus according to an embodiment of the present disclosure; and

FIG. 7 is a block diagram of a CPU resource control apparatus according to an embodiment of the present disclosure.

### DETAILED DESCRIPTION

Some implementations of the present disclosure are described below with reference to the accompanying drawings. Those skilled in the art should understand that these implementations are only used to explain the technical principles of the present disclosure, and are not intended to limit the protection scope of the present disclosure.

In the description of the present disclosure, a “module” or “processor” may include hardware, software, or a combination thereof. A module may include a hardware circuit, various suitable sensors, a communication port, and a memory, or may include a software part, such as program code, or may be a combination of software and hardware. The processor may be a central processing unit, a microprocessor, a digital signal processor, or any other suitable processor. The processor has a data and/or signal processing function. The processor may be implemented in software, hardware, or a combination thereof. A non-transitory computer-readable storage medium includes any suitable medium that can store program code, such as a magnetic disk, a hard disk, an optical disc, a flash memory, a read-only memory, or a random access memory. The term “A and/or B” indicates all possible combinations of A and B, for example, only A, only B, or A and B. The term “at least one of A or B” or “at least one of A and B” has a meaning similar to “A and/or B” and may include only A, only B, or A and B. The terms “a/an” and “this” in the singular form may also include the plural form.

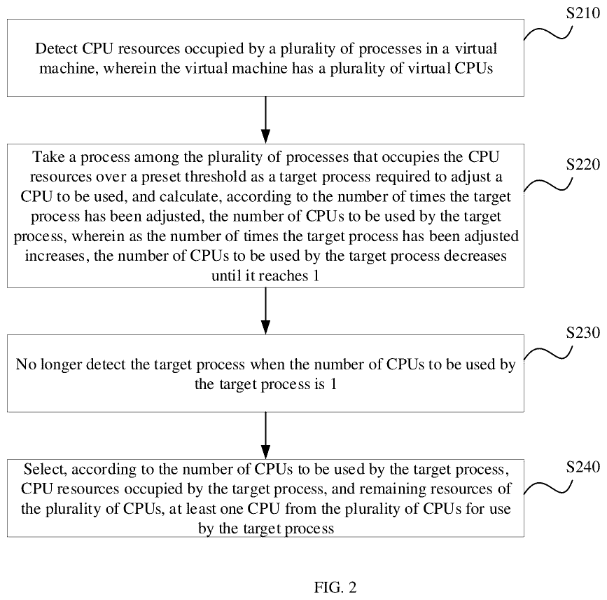

As shown in FIG. 2, in an embodiment of the present disclosure, a CPU resource control method is provided. The method includes the following steps.

In step S210, CPU resources occupied by a plurality of processes in a virtual machine are detected, wherein the virtual machine has a plurality of virtual CPUs (i.e., the foregoing vCPUs). For example, CPU resource occupied by each of the plurality of processes in the virtual machine is detected, wherein the virtual machine has a plurality of virtual CPUs (i.e., the foregoing vCPUs).

In the virtual machine, CPU usage of a single process is not a constant, but a variable related to a total number of processes. When the number of processes increases, the CPU usage of the single process also increases. This is because a CPU usage index of the single process includes time overhead of a single virtual IPI (i.e., vIPI). This overhead may increase as the total number of virtual IPIs increases. Test data is as follows:

| | Average CPU usage |
|---|---|
| Number of test processes | per process (%) |
| 4 | 7-8 |
| 8 | 7-8 |
| 12 | 12 |
| 20 | 14 |

In step S220, a process among the plurality of processes that occupies the CPU resources over a preset threshold is taken as a target process required to adjust a CPU to be used, and the number of CPUs to be used by the target process is calculated according to the number of times the target process has been adjusted, wherein as the number of times the target process has been adjusted increases, the number of CPUs to be used by the target process decreases until it reaches 1.

In this embodiment, a process in the virtual machine whose occupation of CPU resources reaches a threshold is taken as a target process and a virtual CPU to be used is adjusted to achieve CPU load balancing, which is different from the existing technical solution in that, as the number of times of load balancing increases, the number of CPUs configured for the target process gradually decreases, thereby reducing the number of vIPIs generated by migration of the target process between virtual CPUs, that is, reducing a waste of CPU resources in the virtual machine.

In step S230, the target process is no longer detected when the number of CPUs to be used by the target process is 1.

In this embodiment, when the number of virtual CPUs allocated to the target process is 1, the number of virtual CPUs cannot be further reduced for the target process, that is, the waste of CPU resources in the virtual machine is minimized. Therefore, there is no need to detect the target process.

In step S240, at least one CPU from the plurality of CPUs for use by the target process is selected according to the number of CPUs to be used by the target process, CPU resources occupied by the target process, and remaining resources of the plurality of CPUs.

In this embodiment, the waste of CPU resources in virtualization application scenarios is reduced by reducing the number of vIPIs for CPU load balancing in the virtual machine. After the technical solution of this embodiment is used, CPU usage of each process increases initially, but becomes constant after reaching a configured threshold. When the total number of processes continues to increase, CPU usage of a single process remains at a fixed value, and a new process does not introduce more additional CPU usage. Test data is as follows:

| | Average CPU usage |
|---|---|
| Number of test processes | per process (%) |
| 4 | 7-8 |
| 8 | 7-8 |
| 12 | 7-8 |
| 20 | 7-8 |

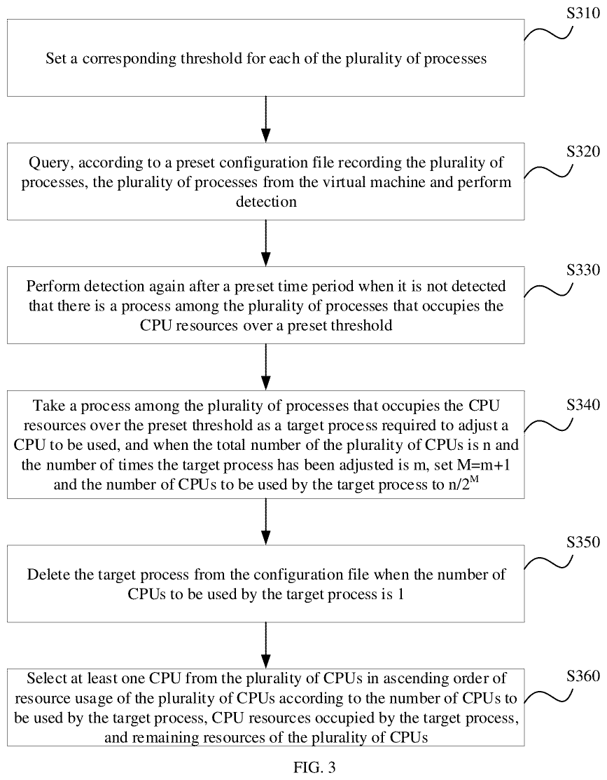

As shown in FIG. 3, in an embodiment of the present disclosure, a CPU resource control method is provided. The method includes the following steps.

In step S310, a corresponding threshold is set for each of the plurality of processes.

In this embodiment, two manners of setting thresholds for processes are provided.

(1) The corresponding threshold is set for each process according to a degree of dependence of a task executed by the virtual machine on each process. Herein, a process highly dependent on the task is provided with more CPU resources to ensure that the task can be executed normally in the virtual machine.

(2) The corresponding threshold is set for each process according to a degree of impact of each process on stability of a running system of the virtual machine. Herein, a process having a greater impact on system stability is provided with more CPU resources to ensure that the virtual machine can run smoothly.

In step S320, according to a preset configuration file recording the plurality of processes, the plurality of processes is queried from the virtual machine and detection is performed.

In this embodiment, process thresholds are recorded through the preset configuration file, and a form may be as follows:
[Process] [Allowed maximum CPU usage threshold]
[Process] [Allowed maximum CPU usage threshold]
[Process] [Allowed maximum CPU usage threshold] . . .

In step S330, detection is performed again after a preset time period when it is not detected that there is a process among the plurality of processes that occupies the CPU resources over a preset threshold.

In this embodiment, the preset time period is not limited, which may be, for example, 5 s. In this embodiment, process detection is performed on the virtual machine according to the preset time period to ensure timely discovery of processes that occupy excessive CPU resources.

In step S340, a process among the plurality of processes that occupies the CPU resources over the preset threshold is taken as a target process required to adjust a CPU to be used, and when the total number of the plurality of CPUs is n and the number of times the target process has been adjusted is m, M=m+1 is set, and the number of CPUs to be used by the target process is set to n/2^{M}.

Herein, a specific solution of calculating the number of CPUs to be used by the target process based on the number of times of adjustment is provided. For example, assuming that the total number of CPUs is n=8 and the number of times the target process has been adjusted during a first adjustment is m=0, M=m+1=1, and the number of CPUs to be used by the target process is the number of times the target process has been adjusted, which is n/2=4. When the number of times the target process has been adjusted during a second adjustment is m=1, M=m+1=2, and the number of CPUs to be used by the target process is the number of times the target process has been adjusted, which is n/2²=8/4=2.

In step S350, the target process is deleted from the configuration file when the number of CPUs to be used by the target process is 1.

In this embodiment, detection process scope control can be quickly completed through the configuration file.

In step S360, at least one CPU is selected from the plurality of CPUs in ascending order of resource usage of the plurality of CPUs according to the number of CPUs to be used by the target process, CPU resources occupied by the target process, and remaining resources of the plurality of CPUs.

In this embodiment, CPUs with fewer resources occupied currently are prioritized to provide resources for the target process, which is conducive to a balanced adjustment on a load level of each CPU.

Based on the technical solutions of the above embodiments, the following two programs may be implemented.

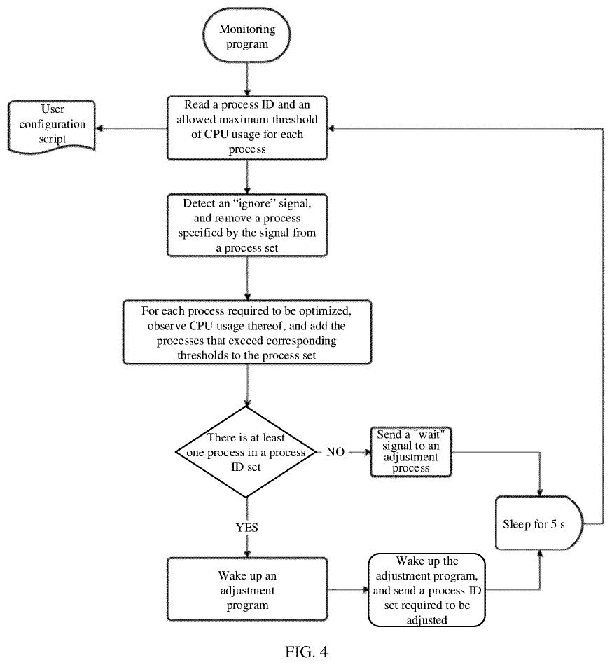

A monitoring program, whose workflow is shown in FIG. 4, is used to parse a user configuration file and monitor CPU usage of processes.

(1) A user configures a specified process group required to be optimized through a configuration script, such as processes a, b, c, and d, and an allowed maximum CPU usage threshold for each process, such as 11%.

(2) A thread of the monitoring program interprets the configuration file and parses that maximum CPU usage thresholds allowed for the processes a, b, c, and d are 10%, 20%, 10%, and 15% respectively.

(3) A monitoring thread removes, according to a previously received ignore request sent from a program adjustment thread, a process required to be ignored from the processes, which is the process a in this example.

(4) The monitoring thread observes CPU usage of each process in the process group required to be optimized, which are the processes b, c, and d in this example. in response to the CPU usage of each process not exceeding a maximum threshold, the monitoring thread sends a “wait” signal to an adjustment thread. In response to usage of one or more processes exceeding the maximum threshold, such as the processes b and c, the monitoring program wakes up a sleeping adjustment program and sends the processes b and c to the adjustment thread.

(5) The monitoring thread enters a 5-s sleep waiting state and returns to step (2) after 5 s.

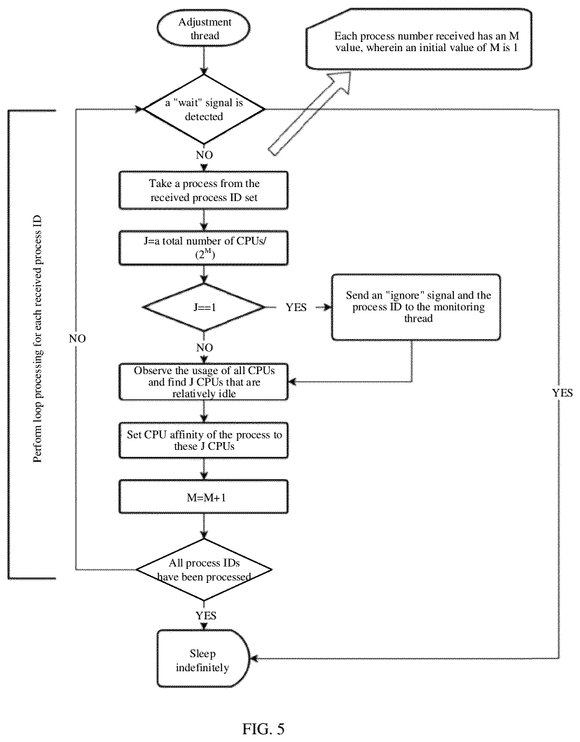

An adjustment program, whose workflow is shown in FIG. 5, is used to adjust CPU affinity of the processes.

(1) The adjustment program is woken and then detects a “wait” signal.

(2) In response to the “wait” signal being received, the adjustment program enters indefinite sleep until woken up by the monitoring process.

(3) In response to the “wait” signal not being received, indicating that there are processes currently required to be adjusted, next step is performed.

(4) The adjustment thread receives the processes required to be adjusted and creates a corresponding M value for each process required to be adjusted. M is initialized to 1. In this example, the processes are b and c, and M=1 for the processes b and c respectively.

(5) The following same operations are sequentially performed on the processes b and c. Taking the process b as an example, a state of usage of each CPU in the current system is observed, and a CPU set with a relatively small load is found. A size of the set is (the total number of system CPUs/(2M)). For example, if the total number of CPUs=8 and M=1, then (8/(2¹)=4. Then, in the 8 CPUs, 4 CPUs with smaller loads are observed. In this example, CPU0, CPU1, CPU2, and CPU3 are selected. If the number of CPU selected in this step is already single, indicating that the CPU affinity of this process reaches a single CPU and that the process is no longer affected by the load balancing operation, the operating system may not generate vIPIs for these processes, and there is no more room for optimization, an “ignore” signal and this process are sent to the monitoring thread to notify the monitoring thread to ignore monitoring this process. The CPU affinity of this process is set to the selected CPU set, and the M value of this process is increased by 1. In this example, M=2 for the process b. Return to step (1) and repeat until all the processes are completed. In this example, b and c are completed.

(6) The adjustment program enters indefinite sleep until woken up by the monitoring program.

According to the technical solution of this embodiment, vIPIs generated by process migration in the virtual machine can be effectively reduced, thereby reducing the waste of CPU resources caused by load balancing.

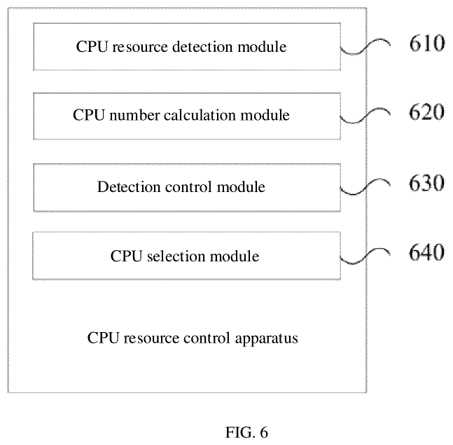

As shown in FIG. 6, in an embodiment of the present disclosure, a CPU resource control apparatus is provided. The apparatus includes the following modules.

A CPU resource detection module 610 is configured to detect CPU resources occupied by a plurality of processes in a virtual machine, wherein the virtual machine has a plurality of virtual CPUs (i.e., the foregoing vCPUs).

In the virtual machine, CPU usage of a single process is not a constant, but a variable related to a total number of processes. When the number of processes increases, the CPU usage of the single process also increases. This is because a CPU usage index of the single process includes time overhead of a single virtual IPI (i.e., vIPI). This overhead may increase as the total number of virtual IPIs increases. Test data is as follows:

| | Average CPU usage |
|---|---|
| Number of test processes | per process (%) |
| 4 | 7-8 |
| 8 | 7-8 |
| 12 | 12 |
| 20 | 14 |

A CPU number calculation module 620 is configured to take a process among the plurality of processes that occupies the CPU resources over a preset threshold as a target process required to adjust a CPU to be used, and calculate, according to the number of times the target process has been adjusted, the number of CPUs to be used by the target process, wherein as the number of times the target process has been adjusted increases, the number of CPUs to be used by the target process decreases until it reaches 1.

In this embodiment, a process in the virtual machine whose occupation of CPU resources reaches a threshold is taken as a target process and a virtual CPU to be used is adjusted to achieve CPU load balancing, which is different from the existing technical solution in that, as the number of times of load balancing increases, the number of CPUs configured for the target process gradually decreases, thereby reducing the number of vIPIs generated by migration of the target process between virtual CPUs, that is, reducing a waste of CPU resources in the virtual machine.

A detection control module 630 is configured to no longer detect the target process when the number of CPUs to be used by the target process is 1.

In this embodiment, when the number of virtual CPUs allocated to the target process is 1, the number of virtual CPUs cannot be further reduced for the target process, that is, the waste of CPU resources in the virtual machine is minimized. Therefore, there is no need to detect the target process.

A CPU selection module 640 is configured to select, according to the number of CPUs to be used by the target process, CPU resources occupied by the target process, and remaining resources of the plurality of CPUs, at least one CPU from the plurality of CPUs for use by the target process.

In this embodiment, the waste of CPU resources in virtualization application scenarios is reduced by reducing the number of vIPIs for CPU load balancing in the virtual machine. After the technical solution of this embodiment is used, CPU usage of each process increases initially, but becomes constant after reaching a configured threshold. When the total number of processes continues to increase, CPU usage of a single process remains at a fixed value, and a new process does not introduce more additional CPU usage. Test data is as follows:

| | Average CPU usage |
|---|---|
| Number of test processes | per process (%) |
| 4 | 7-8 |
| 8 | 7-8 |
| 12 | 7-8 |
| 20 | 7-8 |

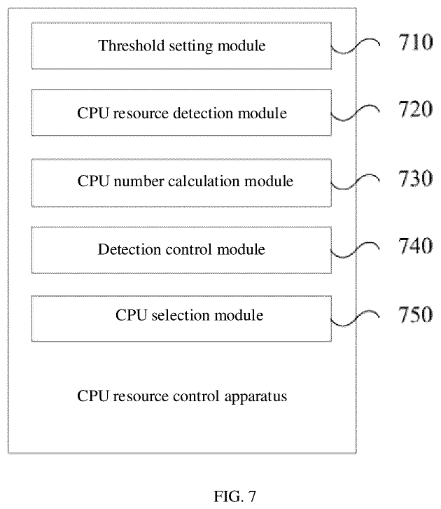

As shown in FIG. 7, in an embodiment of the present disclosure, a CPU resource control apparatus is provided. The apparatus includes the following modules.

A threshold setting module 710 is configured to set a corresponding threshold for each of the plurality of processes.

In this embodiment, two manners of setting thresholds for processes are provided.

(1) The corresponding threshold is set for each process according to a degree of dependence of a task executed by the virtual machine on each process. Herein, a process highly dependent on the task is provided with more CPU resources to ensure that the task can be executed normally in the virtual machine.

(2) The corresponding threshold is set for each process according to a degree of impact of each process on stability of a running system of the virtual machine. Herein, a process having a greater impact on system stability is provided with more CPU resources to ensure that the virtual machine can run smoothly.

A CPU resource detection module 720 is configured to query, according to a preset configuration file recording the plurality of processes, the plurality of processes from the virtual machine and perform detection.

In this embodiment, process thresholds are recorded through the preset configuration file, and a form may be as follows:
[Process] [Allowed maximum CPU usage threshold]
[Process] [Allowed maximum CPU usage threshold]
[Process] [Allowed maximum CPU usage threshold] . . .

The CPU resource detection module 720 performs detection again after a preset time period when it is not detected that there is a process among the plurality of processes that occupies the CPU resources over the preset threshold.

In this embodiment, the preset time period is not limited, which may be, for example, 5 s. In this embodiment, process detection is performed on the virtual machine according to the preset time period to ensure timely discovery of processes that occupy excessive CPU resources.

A CPU number calculation module 730 is configured to take a process among the plurality of processes that occupies the CPU resources over a preset threshold as a target process required to adjust a CPU to be used, and when the total number of the plurality of CPUs is n and the number of times the target process has been adjusted is m, set M=m+1 and the number of CPUs to be used by the target process to n/2^{M}.

Herein, a specific solution of calculating the number of CPUs to be used by the target process based on the number of times of adjustment is provided. For example, assuming that the total number of CPUs is n=8 and the number of times the target process has been adjusted during a first adjustment is m=0, M=m+1=1, and the number of CPUs to be used by the target process is the number of times the target process has been adjusted, which is n/2=4. When the number of times the target process has been adjusted during a second adjustment is m=1, M=m+1=2, and the number of CPUs to be used by the target process is the number of times the target process has been adjusted, which is n/2²=8/4=2.

A detection control module 740 is configured to delete the target process from the configuration file when the number of CPUs to be used by the target process is 1.

In this embodiment, detection process scope control can be quickly completed through the configuration file.

A CPU selection module 750 is configured to select at least one CPU from the plurality of CPUs in ascending order of resource usage of the plurality of CPUs according to the number of CPUs to be used by the target process, CPU resources occupied by the target process, and remaining resources of the plurality of CPUs.

In this embodiment, CPUs with fewer resources occupied currently are prioritized to provide resources for the target process, which is conducive to a balanced adjustment on a load level of each CPU.

Based on the technical solutions of the above embodiments, the following two programs may be implemented.

A monitoring program, whose workflow is shown in FIG. 4, is used to parse a user configuration file and monitor CPU usage of processes.

(1) A user configures a specified process group required to be optimized through a configuration script, such as processes a, b, c, and d, and an allowed maximum CPU usage threshold for each process, such as 11%.

(2) A thread of the monitoring program interprets the configuration file and parses that maximum CPU usage thresholds allowed for the processes a, b, c, and d are 10%, 20%, 10%, and 15% respectively.

(3) A monitoring thread removes, according to a previously received ignore request sent from a program adjustment thread, a process required to be ignored from the processes, which is the process a in this example.

(4) The monitoring thread observes CPU usage of each process in the process group required to be optimized, which are the processes b, c, and d in this example. In response to the CPU usage of each process not exceeding a maximum threshold, the monitoring thread sends a “wait” signal to an adjustment thread. In response to usage of one or more processes exceeding the maximum threshold, such as the processes b and c, the monitoring program wakes up a sleeping adjustment program and sends the processes b and c to the adjustment thread.

(5) The monitoring thread enters a 5-s sleep waiting state and returns to step (2) after 5 s.

An adjustment program, whose workflow is shown in FIG. 5, is used to adjust CPU affinity of the processes.

(1) The adjustment program is woken and then detects a “wait” signal.

(2) In response to the “wait” signal being received, the adjustment program enters indefinite sleep until woken up by the monitoring process.

(3) In response to the “wait” signal not being received, indicating that there are processes currently required to be adjusted, next step is performed.

(4) The adjustment thread receives the processes required to be adjusted and creates a corresponding M value for each process required to be adjusted. M is initialized to 1. In this example, the processes are b and c, and M=1 for the processes b and c respectively.

(5) The following same operations are sequentially performed on the processes b and c. Taking the process b as an example, a state of usage of each CPU in the current system is observed, and a CPU set with a relatively small load is found. A size of the set is (the total number of system CPUs/(2^{M})). For example, if the total number of CPUs=8 and M=1, then (8/(2¹)=4. Then, in the 8 CPUs, 4 CPUs with smaller loads are observed. In this example, CPU0, CPU1, CPU2, and CPU3 are selected. If the number of CPU selected in this step is already single, indicating that the CPU affinity of this process reaches a single CPU and that the process is no longer affected by the load balancing operation, the operating system may not generate vIPIs for these processes, and there is no more room for optimization, an “ignore” signal and this process are sent to the monitoring thread to notify the monitoring thread to ignore monitoring this process. The CPU affinity of this process is set to the selected CPU set, and the M value of this process is increased by 1. In this example, M=2 for the process b. Return to step (1) and repeat until all the processes are completed. In this example, b and c are completed.

(6) The adjustment program enters indefinite sleep until woken up by the monitoring program.

According to the technical solution of this embodiment, vIPIs generated by process migration in the virtual machine can be effectively reduced, thereby reducing the waste of CPU resources caused by load balancing.

The present disclosure further provides a computer-readable storage medium. In an embodiment of the computer-readable storage medium according to the present disclosure, the computer-readable storage medium may be configured to store a program that performs the CPU resource control method in the above method embodiments. The program may be loaded and run by a processor to implement the above CPU resource control method. For ease of description, only parts related to this embodiment of the present disclosure are shown. For specific technical details that are not disclosed, reference may be made to the method part in the embodiments of the present disclosure. The computer-readable storage medium may be a storage device formed by various electronic devices. Optionally, the computer-readable storage medium in the embodiments of the present disclosure is a non-transitory computer-readable storage medium.

Algorithms and display provided herein are not inherently related to a particular computer, virtual system or other devices. Various general-purpose systems may also be used with teaching based on this. According to the above description, the required structure for constructing such a system is obvious. In addition, the present disclosure is not directed to any particular programming language. It should be understood that the content of the present disclosure described herein may be implemented using a variety of programming languages, and the above description of specific languages are intended to disclose the best implementation of the present disclosure.

Many details are discussed in the specification provided herein. However, it should be understood that the embodiments of the present disclosure can be implemented without these specific details. In some examples, well-known methods, structures, and technologies are not shown in detail so as to avoid an unclear understanding of the specification.

Similarly, it should be understood that, in order to simplify the present disclosure and to facilitate the understanding of one or more of various aspects thereof, in the above description of the exemplary embodiments of the present disclosure, various features of the present disclosure may sometimes be grouped together into a single embodiment, figure, or description thereof. However, the method of the disclosure should not be constructed as follows: the present disclosure for which the protection is sought claims more features than those explicitly disclosed in each of the claims. More specifically, as reflected in the following claims, the inventive aspect is in that the features therein are less than all features of a single embodiment as disclosed above. Therefore, the claims following specific embodiments are definitely incorporated into the specific embodiments, wherein each of the claims may be considered as a separate embodiment of the present disclosure.

It should be understood by those skilled in the art that modules of the device in the embodiments may be adaptively modified and arranged in one or more devices different from the embodiment. Modules, units, or components in the embodiments may be combined into one module, unit, or component, and may alternatively be divided into more sub-modules, sub-units, or sub-components. Except that at least some of features and/or processes or units are mutually exclusive, various combinations may be used to combine all the features disclosed in the specification (including claims, abstract, and accompanying figures) and all the processes or units of any methods or devices as disclosed herein. Unless otherwise definitely stated, each of features disclosed in the specification (including claims, abstract, and accompanying figures) may be replaced with an alternative feature having a same, equivalent, or similar purpose.

In addition, it should be understood by those skilled in the art, although some embodiments as described herein include some features included in other embodiment rather than other features, a combination of features in different embodiment means that the combination falls within the scope of the present disclosure and forms a different embodiment. For example, in the claims, any one of the embodiments for which the protection is sought may be used in any combination manner.

Various component embodiments of the present disclosure may be implemented by hardware, or implemented by software modules operating on one or more processors, or implemented by a combination thereof. Those of skilled in the art should understand that, in practice, a microprocessor or a digital signal processor (DSP) may be used to implement some or all functions of some or all components in a processing apparatus of a mobile terminal according to embodiments of the present disclosure. The present disclosure may further be implemented as a device or apparatus program (e.g., a computer program and a computer program product) for performing part or all of the methods described herein. Such a program implementing the present disclosure may be stored in a computer-readable medium, or may be in the form of one or more signals. Such signals may be downloaded from an Internet website, or provided on a carrier signal, or provided in any other form.

It should be noted that the above embodiments illustrate the present disclosure rather than limit the present disclosure, and those skilled in the art can design alternative embodiments without departing from the scope of the appended claims. In the claims, any reference signs placed between parentheses should not be constructed as a limitation on the claims. The word “comprising” does not exclude the presence of elements or steps not listed in the claims. The word “a/an” or “one” preceding an element does not exclude the presence of multiple such elements. The present disclosure can be implemented by means of hardware including several different elements and by means of a suitably programmed computer. In the unit claims enumerating several apparatuses, several of these apparatuses may be embodied in a same hardware item. The use of the words “first”, “second”, “third” and the like does not indicate any order. These words may be interpreted as names.

1. A CPU resource control method, comprising:
detecting CPU resources occupied by a plurality of processes in a virtual machine, wherein the virtual machine has a plurality of virtual CPUs;
taking a process among the plurality of processes that occupies the CPU resources over a preset threshold as a target process required to adjust a virtual CPU to be used, and calculating, according to the number of times the target process has been adjusted, the number of virtual CPUs to be used by the target process, wherein as the number of times the target process has been adjusted increases, the number of virtual CPUs to be used by the target process decreases until it reaches 1;
no longer detecting the target process when the number of virtual CPUs to be used by the target process is 1; and
selecting, according to the number of virtual CPUs to be used by the target process, CPU resources occupied by the target process, and remaining resources of the plurality of virtual CPUs, at least one virtual CPU from the plurality of virtual CPUs for use by the target process.

2. The method according to claim 1, further comprising, prior to the step of taking the process among the plurality of processes that occupies the CPU resources over the preset threshold as the target process required to adjust the virtual CPU to be used:
setting a corresponding threshold for each of the plurality of processes.

3. The method according to claim 2, wherein the step of setting the corresponding threshold for each of the plurality of processes comprises:
setting the corresponding threshold for each process according to a degree of dependence of a task executed by the virtual machine on each process.

4. The method according to claim 2, wherein the step of setting the corresponding threshold for each of the plurality of processes comprises:
setting the corresponding threshold for each process according to a degree of impact of each process on stability of a running system of the virtual machine.

5. The method according to claim 1, further comprising:
performing detection again after a preset time period when it is not detected that there is a process among the plurality of processes that occupies the CPU resources over the preset threshold.

6. The method according to claim 1, wherein the step of calculating, according to the number of times the target process has been adjusted, the number of virtual CPUs to be used by the target process comprises:
when the total number of the plurality of virtual CPUs is n and the number of times the target process has been adjusted is m, setting M=m+1 and the number of virtual CPUs to be used by the target process to n/2^{M}.

7. The method according to claim 1, wherein the step of detecting CPU resources occupied by the plurality of processes in the virtual machine comprises:
querying, according to a preset configuration file recording the plurality of processes, the plurality of processes from the virtual machine and performing detection; and
the step of no longer detecting the target process when the number of virtual CPUs to be used by the target process is 1 comprises:
deleting the target process from the configuration file.

8. The method according to claim 1, wherein the step of selecting, according to the number of CPUs to be used by the target process, CPU resources occupied by the target process, and remaining resources of the plurality of CPUs, at least one CPU from the plurality of CPUs for use by the target process further comprises:
selecting the at least one virtual CPU from the plurality of virtual CPUs in an ascending order of resource usage of the plurality of virtual CPUs.

9. A CPU resource control apparatus, comprising a memory coupled to the processor, the memory storing a computer program, wherein when the computer program is executed by the processor, the processor is caused to perform operations comprising:
detecting CPU resources occupied by a plurality of processes in a virtual machine, wherein the virtual machine has a plurality of virtual CPUs;
taking a process among the plurality of processes that occupies the CPU resources over a preset threshold as a target process required to adjust a virtual CPU to be used, and calculate, according to the number of times the target process has been adjusted, the number of virtual CPUs to be used by the target process, wherein as the number of times the target process has been adjusted increases, the number of virtual CPUs to be used by the target process decreases until it reaches 1;
no longer detecting the target process when the number of virtual CPUs to be used by the target process is 1; and
selecting, according to the number of virtual CPUs to be used by the target process, CPU resources occupied by the target process, and remaining resources of the plurality of virtual CPUs, at least one virtual CPU from the plurality of virtual CPUs for use by the target process.

10. A non-transitory computer-readable storage medium, storing a plurality of program codes, wherein the program codes are adapted to be loaded and run by a processor to perform a CPU resource control method, the method comprising:
detecting CPU resources occupied by a plurality of processes in a virtual machine, wherein the virtual machine has a plurality of virtual CPUs;
taking a process among the plurality of processes that occupies the CPU resources over a preset threshold as a target process required to adjust a virtual CPU to be used, and calculating, according to the number of times the target process has been adjusted, the number of virtual CPUs to be used by the target process, wherein as the number of times the target process has been adjusted increases, the number of virtual CPUs to be used by the target process decreases until it reaches 1;
no longer detecting the target process when the number of virtual CPUs to be used by the target process is 1; and
selecting, according to the number of virtual CPUs to be used by the target process, CPU resources occupied by the target process, and remaining resources of the plurality of virtual CPUs, at least one virtual CPU from the plurality of virtual CPUs for use by the target process.
